(19) United States
(12) Patent Application Publication
(10) Pub. No.: US 2026/0336114 A1
(43) Pub. Date: Oct. 29, 2026

(54) DIFFUSION OFF-POLICY EVALUATION

(71) Applicant: Toyota Research Institute, Inc., Los Altos, CA (US)

(72) Inventors: Mikhal Itkina, Los Altos, CA (US); Haruki Nishimura, Los Altos, CA (US); Hossein Goli, Toronto (CA); Michael Gimelfarb, Toronto (CA); Nathan de Lara, Toronto (CA); Florian Shkurti, Toronto (CA)

(73) Assignees: Toyota Research Institute, Inc., Los Altos, CA (US); Toyota Jidosha Kabushiki Kaisha, Toyota-shi Aichi-ken (JP); The Governing Council of the University of Toronto, Toronto (CA)

(21) Appl. No.: 19/431,428

(22) Filed: Dec. 23, 2025

Related U.S. Application Data
(60) Provisional application No. 63/794,645, filed on Apr. 25, 2025.
(60) Provisional application No. 63/801,335, filed on May 7, 2025.

(51) Int. Cl. B25J 9/16; G06N 3/008; G06N 3/0475; G06N 3/092

(52) U.S. Cl. CPC B25J 9/1664; B25J 9/163; G06N 3/008; G06N 3/0475; G06N 3/092

(57) ABSTRACT

A method includes receiving behavior data comprising robot trajectories associated with a behavior policy, each having a first length, dividing the robot trajectories into sub-trajectories, each having a second length smaller than the first length, to generate modified behavior data, training a diffusion model, based on the modified behavior data, to receive Gaussian noise having the second length, and output a predicted behavior trajectory having the second length, thereby generating a trained diffusion model, training a neural network, based on the behavior data, to receive a state and action and output a predicted reward, thereby generating a trained neural network, using a guided diffusion process on the trained diffusion model to generate target sub-trajectories, having the second length, based on a target policy, concatenating the target sub-trajectories to generate a target trajectory having the first length, and evaluating the target trajectory using the trained neural network.

### CROSS-REFERENCE TO RELATED APPLICATION

The present specification is based on, and claims the benefit of, U.S. Provisional Application No. 63/794,645, filed Apr. 25, 2025, and U.S. Provisional Application No. 63/801,335, filed May 7, 2025, the disclosures of which are hereby incorporated by reference in their entirety.

### TECHNICAL FIELD

The present specification relates to training a robot to perform actions using reinforcement learning, and more particularly, to diffusion off-policy evaluation.

### BACKGROUND

One way to train a robot to perform a particular action is via demonstration using reinforcement learning with actual robots or in a simulated environment. However, due to the slow or inherently dangerous nature of online data collection in real-world environments, many successful real-world applications of reinforcement learning use offline data for learning and evaluation. That is, a policy for performing a robot action may be learned using pre-collected, static datasets.

One component of offline reinforcement learning is off-policy evaluation, in which the performance of target policies are evaluated using offline data collected from other behavior policies. This allows for the evaluation of one policy based on rollouts associated with another policy, thereby reducing the number of rollouts needed to be performed. However, a challenge when using off-policy evaluation is the presence of a distribution shift induced by differences between behavior policies and target policies. This may lead to inaccuracies in policy evaluation, making it difficult to select among multiple target policies before they are deployed. Accordingly, there is a need for improved diffusion off-policy evaluation.

### SUMMARY

In one embodiment, a method includes receiving behavior data comprising a plurality of robot trajectories associated with a behavior policy, each of the robot trajectories having a first length; dividing each of the robot trajectories into a plurality of sub-trajectories, each having a second length smaller than the first length, to generate modified behavior data; training a diffusion model, based on the modified behavior data, to receive Gaussian noise having the second length as input, and output a predicted behavior trajectory having the second length, thereby generating a trained diffusion model; training a neural network, based on the behavior data, to receive a state and an action as inputs and output a predicted reward, thereby generating a trained neural network; using a guided diffusion process on the trained diffusion model to generate a plurality of target sub-trajectories, having the second length, based on a target policy; concatenating the target sub-trajectories to generate a target trajectory having the first length; and evaluating the target trajectory using the trained neural network

In another embodiment, a computing device includes one or more processors configured to receive behavior data comprising a plurality of robot trajectories associated with a behavior policy, each of the robot trajectories having a first length; divide each of the robot trajectories into a plurality of sub-trajectories, each having a second length smaller than the first length, to generate modified behavior data; train a diffusion model, based on the modified behavior data, to receive Gaussian noise having the second length as input, and output a predicted behavior trajectory having the second length, thereby generating a trained diffusion model; train a neural network, based on the behavior data, to receive a state and an action as inputs and output a predicted reward, thereby generating a trained neural network; use a guided diffusion process on the trained diffusion model to generate a plurality of target sub-trajectories, having the second length, based on a target policy; concatenate the target sub-trajectories to generate a target trajectory having the first length; and evaluate the target trajectory using the trained neural network.

In another embodiment, a non-transitory computer readable storage medium stores a program. When executed ty one or more processors, the program causes the one or more processors to receive behavior data comprising a plurality of robot trajectories associated with a behavior policy, each of the robot trajectories having a first length; divide each of the robot trajectories into a plurality of sub-trajectories, each having a second length smaller than the first length, to generate modified behavior data; train a diffusion model, based on the modified behavior data, to receive Gaussian noise having the second length as input, and output a predicted behavior trajectory having the second length, thereby generating a trained diffusion model; train a neural network, based on the behavior data, to receive a state and an action as inputs and output a predicted reward, thereby generating a trained neural network; use a guided diffusion process on the trained diffusion model to generate a plurality of target sub-trajectories, having the second length, based on a target policy; concatenate the target sub-trajectories to generate a target trajectory having the first length; and evaluate the target trajectory using the trained neural network.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1 schematically depicts a computing device for performing diffusion off-policy evaluation, according to one or more embodiments shown and described herein;

FIG. 2A illustrates two data sets of an example two-dimensional continuous navigation problem with Gaussian dynamics, according to one or more embodiments shown and described herein;

FIG. 2B illustrates an example target ground truth policy, according to one or more embodiments shown and described herein;

FIG. 2C illustrates example target policy trajectories generated by naïve full-trajectory guided diffusion methods for the target ground truth policy of FIG. 2B;

FIG. 2D illustrates example target policy trajectories generated using a conditional diffusion model for the target ground truth policy of FIG. 2B, according to one or more embodiments shown and described herein;

FIG. 2E illustrates two data sets of another example two-dimensional continuous navigation problem with Gaussian dynamics, according to one or more embodiments shown and described herein;

FIG. 2F illustrates another example target ground truth policy, according to one or more embodiments shown and described herein;

FIG. 2G illustrates example target policy trajectories generated by naïve full-trajectory guided diffusion methods for the target ground truth policy of FIG. 2F;

FIG. 2H illustrates example target policy trajectories generated using a conditional diffusion model for the target ground truth policy of FIG. 2F, according to one or more embodiments shown and described herein;

FIG. 3 depicts a flowchart of a method of operating the computing device of FIG. 1 to perform diffusion off-policy evaluation, according to one or more embodiments shown and described herein; and

FIG. 4 illustrates operation of the computing device of FIG. 1 to perform diffusion off-policy evaluation, according to one or more embodiments shown and described herein.

### DETAILED DESCRIPTION

The embodiments disclosed herein include methods and systems for diffusion off-policy evaluation. In embodiments, behavior data is received comprising a plurality of robot trajectories associated with a behavior policy. The behavior policy may have been pre-trained on robot demonstration data. A diffusion model is then trained based on the behavior data to obtain a high-fidelity sampling distribution over behavior trajectories. In embodiments, the diffusion model is trained on short sub-trajectories of the behavior data rather than the full rollouts. The sub-trajectory generation is conditioned on the final state of the previously generated sub-trajectory. As such, the trained diffusion model may output a plurality of short sub-trajectories, which may be stitched together to form a full-length trajectory.

In order to account for the distribution shift in the off-line policy evaluation, a guided diffusion process may be used to guide the diffusion denoising process of the diffusion model, during inference, towards trajectories with a large cumulative probability under the target policy. This can eliminate the need to retrain the diffusion model for each new target policy. By training the diffusion model on a variety of behavior datasets, generalization can be achieved during inference to produce feasible trajectories under the target policy, leading to robust off-policy estimates for target policies that lack offline data.

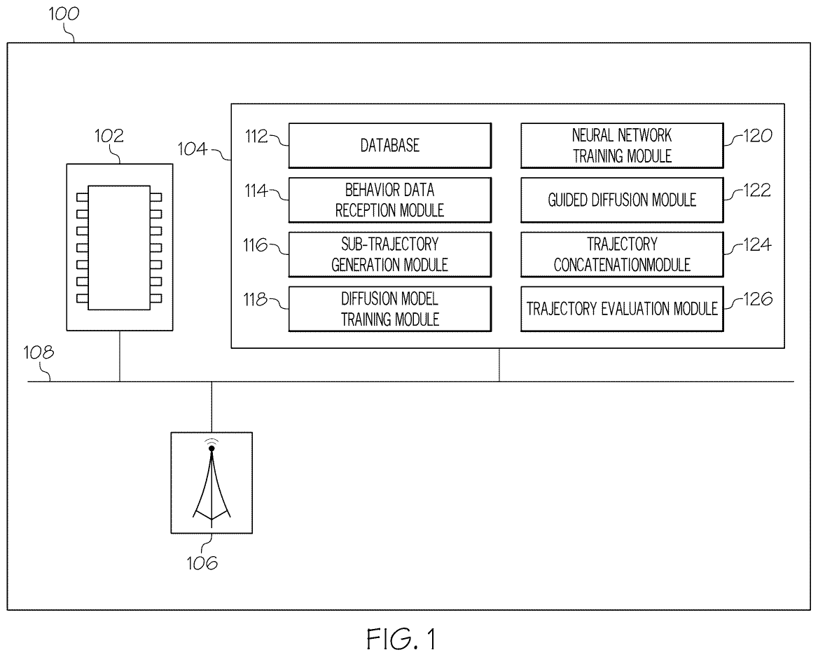

Turning now to the figures, FIG. 1 schematically depicts a computing device 100 for performing diffusion off-policy evaluation. In some examples, the computing device 100 may be embedded in a robot. In other examples, the computing device 100 may be a stand-alone device not embedded in a robot (e.g., a desktop computer, a server, a cloud computing device, and the like).

In the example of FIG. 1, the computing device 100 comprises one or more processors 102, one or more memory modules 104, network interface hardware 106, and a communication path 108. The one or more processors 102 may be a controller, an integrated circuit, a microchip, a computer, or any other computing device. The one or more memory modules 104 may comprise RAM, ROM, flash memories, hard drives, or any device capable of storing machine readable and executable instructions such that the machine readable and executable instructions can be accessed by the one or more processors 102.

The network interface hardware 106 can be communicatively coupled to the communication path 108 and can be any device capable of transmitting and/or receiving data via a network. Accordingly, the network interface hardware 106 can include a communication transceiver for sending and/or receiving any wired or wireless communication. For example, the network interface hardware 106 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 106 includes hardware configured to operate in accordance with the Bluetooth® wireless communication protocol. The network interface hardware 106 of the computing device 100 may transmit and receive data to and from a robot, or other computing devices, as disclosed herein.

The one or more memory modules 104 include a database 112, a behavior data reception module 114, a sub-trajectory generation module 116, a diffusion model training module 118, a neural network training module 120, a guided diffusion module 122, a trajectory concatenation module 124, and a trajectory evaluation module 126. Each of the database 112, the behavior data reception module 114, the sub-trajectory generation module 116, the diffusion model training module 118, the neural network training module 120, the guided diffusion module 122, the trajectory concatenation module 124, and the trajectory evaluation module 126 may be a program module in the form of operating systems, application program modules, and other program modules stored in the one or more memory modules 104. In some embodiments, the program module may be stored in a remote storage device that may communicate with the computing device 100. Such a program module may include, but is not limited to, routines, subroutines, programs, objects, components, data structures and the like for performing specific tasks or executing specific data types as will be described below.

The database 112 may store data used by the various memory modules 104 of the computing device 100. In particular, the database 112 may store trajectory data, policy data, diffusion model parameters, and neural network parameters. The database 112 may also store other data used by the memory modules 104.

The behavior data reception module 114 may receive behavior data, as disclosed herein. In particular, the behavior data reception module 114 may receive behavior data comprising a plurality of robot trajectories associated with a behavior policy. In embodiments, the computing device 100 may be utilized to perform off-policy evaluation, as disclosed herein.

A policy may be associated with a particular task to be performed by a robot. In particular, a policy may observe a current state of a robot, and determine an action to be performed by the robot to reach the next state towards performing the task. More particularly, a standard Markov Decision Process (MDP) may comprise a 6-tuple [symbol] [symbol] ,d₀,γ [symbol] where: [symbol] is a continuous state space, [symbol] is a continuous action space, [symbol] is a reward function, [symbol] is a Markovian transition probability density, d₀ is an initial state density, and γ∈[0,1] is a discount factor.

A policy π: [symbol] × [symbol] →[0, ∞) observes a current state s, chooses an action according to its conditional distribution π(⋅|s) given s, and observes the immediate reward eqr(s, a) and the next state s′~T(⋅|s, a). The interaction of a policy with an MDP generates a set of trajectories of states, action, and rewards. The goal of reinforcement learning is to learn a policy π that maximizes the expected sum of future rewards by observing the interactions with the MDP:

$$J ( π ) = {𝔼}_{( {s}_{0} , {a}_{0} , {s}_{1} , {a}_{1} , … {s}_{T} ) ∼ {p}_{π} [ {\sum }_{t = 0}^{T - 1} {γ}^{t} r ( {s}_{t} , {a}_{t} ) ]} ,$$

where p_{π}(τ)=d₀(s₀)×π(a₀|s₀)×T(s₁|s₀, a₀)× . . . ×π(a_{T-1}|s_{T-1})×T(s_{T}|s_{T-1}, a_{T-1}) is the distribution over length-T trajectories T induced by policy R.

The goal of off-policy evaluation is to estimate the expected sum of future rewards for a target policy π in an MDP, given only a set of observations of different behavior policies β₁, . . . , βₙ interacting with the same MDP. To estimate J(π), it is necessary to approximate the distribution over trajectories p_{π}(τ) induced by policy π using only samples from distributions p_{β}_{₁}(τ), . . . , p_{β}_{ₙ}_{(τ)}. Hence, the phenomenon of distribution shift arises since β₁, . . . , βₙ are expected to be different from π. The direct method generates trajectories induced by π by estimating T and r so that J(π) can be estimated via Monte-Carlo. Given that the estimates of T and rare unbiased, the estimated J(π) will be unbiased as well.

Accordingly, in embodiments, the behavior data reception module 114 may receive behavior data associated with a behavior policy. The behavior policy may be a policy for a robot to perform a particular task, for which an evaluation is available. The behavior data received by the behavior data reception module 114 may comprise trajectories generated by rolling out the behavior policy to generate a series of actions and states performed by a robot according to the behavior policy. A target policy may be a new policy, different from the behavior policy, for which an evaluation is desired without directly rolling out trajectories. This may be desirable to conserve resources. Accordingly, the target policy may be evaluated based on the received behavior data associated with the behavior policy, using the techniques described herein.

Referring still to FIG. 1, the sub-trajectory generation module 116 may divide the robot trajectories received by the behavior data reception module 114 into a plurality of sub-trajectories, as disclosed herein. Each of the sub-trajectories may have a length smaller than the full-length trajectories received by the behavior data reception module 114. As discussed above, and in further detail below, a diffusion model is trained based on behavior data. However, full-length diffusion models often do not provide sufficient compositionality for accurate long-horizon sequence generation. In addition, full-length prediction requires generation of sequences of size T×(| [symbol] |+| [symbol] |), which may not be feasible on resource-constrained systems or when T is sufficiently large.

Accordingly, in embodiments disclosed herein, a conditional diffusion model is trained to generate sub-trajectories of shorter length ω<<T. To allow for more flexible composition of behavior trajectories during guidance, generation is performed in a semi-autoregressive manner from the diffusion model, which is conditioned on the last state of the previously generated sub-trajectory, as discussed in further detail below. Accordingly, in embodiments disclosed herein, the sub-trajectory generation module 116 divides each trajectory of length T received by the behavior data reception module 114 into a plurality of sub-trajectories of length ω. The generated sub-trajectories may be used to train the diffusion model, as disclosed in further detail below.

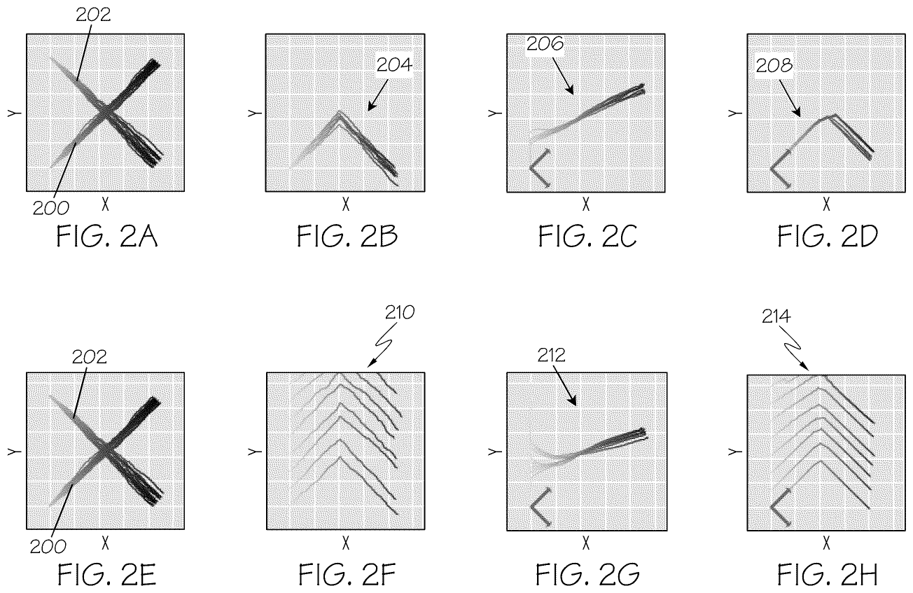

FIG. 2A shows an example two-dimensional continuous navigation problem with Gaussian dynamics. In particular, in the example of FIG. 2A, behavior is generated from a mixture of two data sets 200, 202, from two behavior policies β₁,β₂, respectively, moving an agent (e.g., a robot) in opposite directions. FIG. 2B shows a target ground truth policy 204, which is a piecewise policy following β₁ (behavior data 200) on the left half-space and β₂ (behavior data 202) on the right half-space. FIG. 2C illustrates target policy trajectories 206 that may be generated by naïve full-trajectory guided diffusion. As shown in FIG. 2C, naïve full-trajectory guided diffusion methods are unable to compose the behavior data transitions to generate accurate target policy trajectories. FIG. 2D shows example target policy trajectories 208 that may be generated using the conditional diffusion model to generate sub-trajectories, using the techniques disclosed herein. As shown in FIG. 2D, the disclosed techniques are able to compose the behavior data transitions to generate accurate target policy trajectories.

FIG. 2E depicts a similar example with the same data sets 200, 202 from FIG. 2A. However, FIG. 2F shows a target ground truth policy 210 where the initial state varies prior to guided trajectory generation. FIG. 2G shows example target policy trajectories 212 that may be generated using naïve full-trajectory guided diffusion, which again, is unable to generate accurate target policy trajectories. FIG. 2H shows example target policy trajectories 214 that may be generated using the techniques disclosed herein, for which accurate target policy trajectories are generated.

Referring back to FIG. 1, the diffusion model training module 118 may train a diffusion model, as disclosed herein. A forward noise process applied iteratively to an input may transform the input into noise. As such, a diffusion model may be trained by running the noise process in reverse as a de-noising process to transform Gaussian noise into an input. In embodiments disclosed herein, the forward noise process may apply noise to a behavior trajectory of a robot. As such, the diffusion model training module 118 may train a diffusion model to receive Gaussian noise and a first state of a trajectory as inputs, and generate a predicted behavior trajectory beginning at the first state and ending at the Gaussian noise. The trained diffusion model may be used to evaluate trajectories associated with a target policy, as discussed in further detail below.

In particular, in embodiments, a denoising diffusion probabilistic model (DDPM) may approximate sampling from a given distribution. Given a dataset

$${\{ {x}_{i} \}}_{i = 1}^{N} ∼ p$$

and the K-step (forward) noise process

$${x}_{i}^{k} = \sqrt{1 - {β}_{k}} {x}_{i}^{k - 1} + \sqrt{{β}_{k}} {z}_{k} ,$$

where zₖ~ [symbol] (0,I) are independently and identically distributed and

$${x}_{i}^{0} = {x}_{i} ,$$

a the diffusion model training module 118 may train a DDPM to perform the K-step (backward) de-noising process to recover xᵢ from

$${x}_{i}^{K} ∼ 𝒩 ( 0 , I ) .$$

This may be accomplished by running the forward process

$${x}_{i}^{0} \to {x}_{i}^{k}$$

on the original xᵢ, and training the DDPM, ε_{θ}, on the de-noising process

$${x}_{i}^{k - 1} ∼ 𝒩 ( {μ}_{k} ( {x}_{i}^{k} , {ε}_{θ} ( {x}_{i}^{k} , k ) ) , {σ}_{k}^{2} I )$$

such that the distribution over denoised samples

$${x}_{i}^{k}$$

matches the original data xᵢ. The mean

$${μ}_{k} ( {x}_{i}^{k} , k ) = ( {x}_{i}^{k} - {ε}_{θ} ( {x}_{i}^{k} , k ) {β}_{k} / {σ}_{k} ) / \sqrt{{α}_{k}}$$

maps x^{k} and the predicted noise to x^{k-1}, attempting to undo the noise accumulated during the forward process. By applying reparameterization, the following loss function can be derived for training the diffusion model:

$$ℒ ( θ ) = {E}_{k , {x}_{i} , {ε}_{k} ∼ 𝒩 ( 0 , I )} [ {‖ {ε}_{k} - {ε}_{θ} ( {x}_{i}^{k} , k ) ‖}^{2} ] .$$

Referring still to FIG. 1, the neural network training module 120 may train a neural network, based on the behavior data received by the behavior data reception module 114, to receive a state and an action as inputs and output a predicted reward. In particular, as discussed above, the behavior data received by the behavior data reception module 114 comprises a trajectory including state-action pairs for a plurality of time steps, and a reward associated with each state action-pair. Accordingly, the received behavior data may be used as training data to train the neural network. In particular, the received state-action pairs may be used as inputs to train the neural network, and the received rewards may be used as ground truth data. The neural network training module 120 may train the neural network, using the received behavior data as training data, to predict a reward based on an input state-action pair. The neural network may be used to evaluate a target trajectory, as discussed in further detail below.

Referring still to FIG. 1, the guided diffusion module 122 may use a guided diffusion process on the trained diffusion model, generated by the diffusion model training module 118, to generate a plurality of partial target trajectories. As discussed above, the diffusion model training module 118 may train a diffusion model to output a predicted behavior sub-trajectory. However, because the diffusion model is trained on behavior data associated with a behavior policy, and the goal is to evaluate a target policy, there is a distribution shift between the behavior policy and the target policy. If the distribution shift is significant, the diffusion model may not implement the needed distribution shift. Accordingly, in embodiments, the guided diffusion module 122 may perform guided diffusion, as disclosed herein, to push the diffusion model away from the behavior policy and towards the target policy.

It is possible to guide sampling from a trained diffusion model to maximize some classifier p(y|x). A key observation of diffusion is that the backward diffusion process can be well-approximated as Gaussian when the noise zₖ is small, i.e. p(x^{k}|x^{k+1})= [symbol] (μ,Σ). It is also observed that p(x^{k-1}|x^{k},y)∝p(x^{k}|x^{k+1})p(y|x^{k}). Then, given the first-order Taylor approximation log p(y|x^{k})≈log p(y|p)+(x^{k}−μ)g(μ) at μp, where g(u)=∇ₓ log p(y|x)|ₓ₌ᵤ, it can be shown that:

$$log ( p ( {x}^{k} \vert {x}^{k + 1} ) p ( y \vert {x}^{k} ) ) \approx - \frac{1}{2} {( {x}^{k} - μ - {Σ}_{g} ( μ ) )}^{T} {Σ}^{- 1} ( {x}^{k} - μ - {Σ}_{g} ( μ ) ) + C = log 𝒩 ( {x}^{k} ; μ + Σ g ( μ ) , Σ ) + {C}^{′} ,$$

where C and C′ are normalizing constants. In other words, it is possible to sample from the conditional (guided) distribution p(x^{k-1}|x^{k},y) by sampling from the original diffusion model with its mean shifted to μ+Σ_{g}(μ).

The direct method for off-policy evaluation typically estimates the single-step autoregressive model T(sₜ|sₜ₋₁, aₜ₋₁) and reward function r(sₜ|aₜ) from the behavior data, and draws trajectories T from the length-T trajectory distribution p_{π}(τ) of target policy π via forward sampling, i.e. s₀~d₀, a₀~π(⋅|s₀), s₁~T(⋅|s₀,a₀), . . . s_{T}~T(⋅|sₜ₋₁,aₜ₋₁). However, even small errors in the dynamics model can lead to significant bias in J(π) due to compounding of errors over long horizon T.

A more robust approach approximates the joint distribution p_{π} directly without making use of the Markov assumption. Given a behavior policy β and corresponding length-T trajectory distribution

$${p}_{β} ( τ ) = {d}_{0} ( {s}_{0} ) {\prod }_{t = 0}^{T - 1} β ( {a}_{t} \vert {s}_{t} ) T ( {s}_{t} \vert {s}_{t - 1} , {a}_{t - 1} ) ,$$

the corresponding length-T trajectory distribution of a target policy π can be written as:

$$\begin{matrix}{p}_{π} ( τ ) = {d}_{0} ( {s}_{0} ) {\prod }_{t = 0}^{T - 1} β ( {a}_{t} \vert {s}_{t} ) T ( {s}_{t} \vert {s}_{t - 1 ,} {a}_{t - 1} ) \frac{π ( {a}_{t} \vert {s}_{t} )}{β ( {a}_{t} \vert {s}_{t} )} \\ = {p}_{β} ( τ ) {\prod }_{t = 0}^{T - 1} \frac{π ( {a}_{t} \vert {s}_{t} )}{β ( {a}_{t} \vert {s}_{t} )} .\end{matrix}$$

In embodiments, to address the question of tractably learning p_{β}(τ) by training a diffusion model \hat{p}_{β}(τ) on the behavior data set [symbol] _{β}, thus approximating \hat{p}_{β}(τ)=p_{β}(τ). Specifically, the diffusion model learns to map a trajectory consisting of pure noise

$${τ}^{k} = ( {ε}_{0}^{k} , ⋯ {ε}_{T}^{k} ) ,$$

(into a noiseless behavior trajectory

$${τ}^{0} = ( {s}_{0}^{0} , {a}_{0}^{0} , ⋯ {s}_{T}^{0} ) .$$

In embodiments, the guided diffusion module 122 guides the generation process \hat{p}_{β}(τ) toward p_{π}(τ) through diffusion guidance. Specifically, let x^{k}=τ^{k} denote a noisy behavior trajectory at step k of the forward diffusion process, and let y∈{0,1} be a binary outcome with

$$p ( y = 1 \vert τ ) ∝ {\prod }_{t = 0}^{T - 1} \frac{π ( {a}_{t} \vert {s}_{t} )}{β ( {a}_{t} \vert {s}_{t} )} ,$$

where it is assumed that β(a|s)>0 for all s and a. Accordingly,

p_{π}(τ)∝p_{β}(τ)p(y=1|τ),

and thus the reverse diffusion process for generating target policy trajectories for off-policy evaluation can be approximated with guidance:

log p_{π}(τ^{k-1}|τ^{k})=log(p_{β}(τ^{k-1}|τ^{k})p(y=1|τ^{k}))+C≈log [symbol] (τ^{k}k;μ+τ∇_{T} log p(y=1|τ)|_{τ}_{^{k}},Σ)+C′,

where p_{β}(τ^{k-1}|τ^{k})≈ [symbol] (μ,Σ) is the reverse diffusion process. Therefore, the feasible target policy trajectories can be obtained using the guidance function:

$$g ( τ ) = {∇}_{τ} log p ( y = 1 \vert τ ) = {\sum }_{t = 0}^{T - 1} {∇}_{τ} log π ( {a}_{t} \vert {s}_{t} ) - {\sum }_{t = 0}^{T - 1} {∇}_{τ} log β ( {a}_{t} \vert {s}_{t} ) .$$

Given access to the approximate sampling distribution

$${\hat{p}}_{π} ( {τ}^{0} ) = \int 𝒩 ( {τ}^{K} ; 0 , I ) {\prod }_{k = 1}^{K} {p}_{π} ( {τ}^{k - 1} \vert {τ}^{k} ) d {τ}^{K} ⋯ d {τ}^{1}$$

over target policy trajectories, it is now straightforward to estimate the expected cumulative reward (or any other statistic of the cumulative reward, such as variance or percentile given any target policy, J(π)≈ [symbol] _{tτ~\hat{p}}_{_{π}}_{[Σ}_{ₜ}_{γ}_{^{t}}ᵣ₍ₛ_{ₜ}_{,a}_{ₜ}_{)]}.

Prior work has advocated that the negative guidance term in the above guidance function is unnecessary, instead opting for the simpler guidance function

$${g}_{simple} ( τ ) = {\sum }_{t = 0}^{T - 1} {∇}_{τ} log π ( {a}_{t} \vert {s}_{t} ) .$$

Unfortunately, gₛᵢₘₚₗₑ is not an ideal guidance function for off-policy evaluation, as is shown below.

The pitfalls of gₛᵢₘₚₗₑ can be demonstrated through a 2D continuous navigation problem. Here, the state space [symbol] = [symbol] ² describes all positions (xₜ,yₜ) of the agent at every time t, action space [symbol] = [symbol] describes the angle of motion, and transitions are described by the following equations:

xₜ₊₁=xₜ+0.02×cos(aₜ+εₜ),

yₜ₊₁=yₜ+0.02×sin(aₜ+εₜ),εₜ~ [symbol] (0,0.2).

The behavior policy β is chosen to produce a positive angle in all states, while the target policy π produces a negative angle, to illustrate the effect of distribution shift on the robustness of guidance. The omission of the negative guidance term results in a sampling distribution that collapses to regions of high likelihood under p_{β}(τ) rather than p_{π}(τ). In other words, the negative guidance acts as a repulsion term to prevent the guided sampling distribution from becoming overly regularized by the behavior data.

In embodiments, the following generalization of the guidance function is employed to allow fine-grained control over the relative importance of the target and behavior policy guidance:

$$g ( τ ) = α {\sum }_{t = 0}^{T - 1} {∇}_{τ} log π ( {a}_{t} \vert {s}_{t} ) - λ {\sum }_{t = 0}^{T - 1} {∇}_{τ} log β ( {a}_{t} \vert {s}_{t} ) ,$$

where a typical choice of hyper-parameters is λ<<α. Ignoring the normalizing constant

$${𝒵}_{α , λ}^{π , β} ,$$

which does not dependent on τ, the generalization of the guidance function above is equivalent to sampling from the following re-weighted trajectory distribution:

$${q}_{π} ( τ ) = {𝒵}_{α , λ}^{π , β} \times {p}_{β} ( τ ) \prod \frac{{π ( {a}_{t} \vert {s}_{t} )}^{α}}{{β ( {a}_{t} \vert {s}_{t} )}^{λ}} ,$$

which can be interpreted as a tempered posterior distribution over trajectories, where the importance of the likelihood terms associated with π and β are controlled by the choice of α and λ, respectively. Note that the choice α=λ=1 reduces to the standard guidance function g(τ), while the choice α=1, λ=0 reduces to the simplified guidance gₛᵢₘₚₗₑ(τ).

Referring still to FIG. 1, the trajectory concatenation module 124 may concatenate a plurality of target sub-trajectories to generate full-length trajectories, as disclosed herein. As discussed above, the disclosed diffusion model is trained on short sub-trajectories rather than full-length trajectories. Guided diffusion is then used to generate target sub-trajectories based on the target policy. In order to generate full-length trajectories, the trajectory concatenation module 124 may concatenate the target sub-trajectories to generate a plurality of full-length target trajectories.

Referring still to FIG. 1, the trajectory evaluation module 126 may evaluate the target trajectories output by the trajectory concatenation module 124 using the neural network trained by the neural network training module 120. In particular, the trajectory evaluation module 126 may determine a reward associated with a target trajectory output by the trajectory concatenation module 124. As discussed above, the neural network training module 120 may train a neural network to receive a state and an action as inputs and output a predicted reward associated with the input state-action pair. Accordingly, in embodiments, the trajectory evaluation module 126 may utilize the trained neural network to determine a reward for each state-action pair of a target trajectory output by the trajectory concatenation module 124. The trajectory evaluation module 126 may then determine an overall reward for the target trajectory using a variety of techniques described below.

In one example, the trajectory evaluation module 126 may determine a reward for a target trajectory by computing an average of the reward of each state-action pair of the full-length trajectory. In another example, the trajectory evaluation module 126 may determine a reward for a target trajectory based on rewards associated with each state-action pair of the trajectory using a discount factor, in which a weighted average of the reward of each state-action pair is computed with greater weights given to early sub-trajectories and lesser weights given to later sub-trajectories.

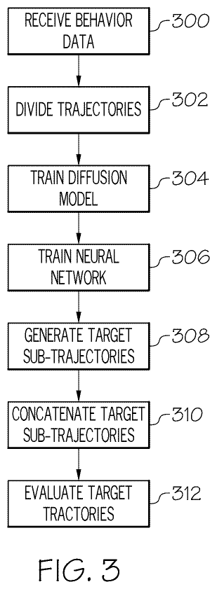

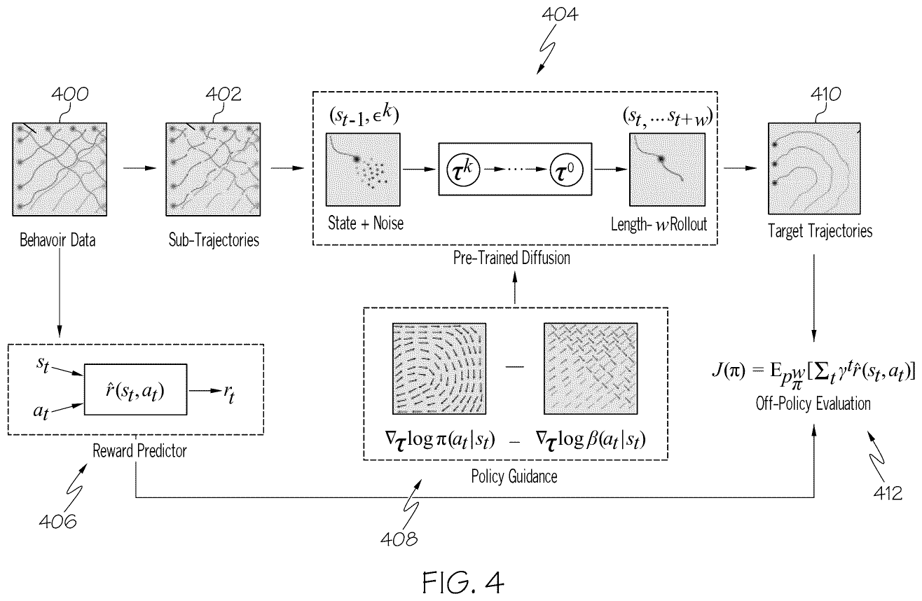

Turning now to FIG. 3, a flowchart of an example method for operating the computing device 100 to perform diffusion off-policy evaluation is shown. This example method is also illustrated in FIG. 4.

Referring to FIG. 3, at step 300, the behavior data reception module 114 receives behavior data comprising a plurality of robot trajectories associated with a behavior policy. In the example of FIG. 4, behavior data 400 is received. In the illustrated example, the behavior data 400 comprises full-length trajectories with each trajectory having a length T.

Referring back to FIG. 3, at step 302, the sub-trajectory generation module 116 divides the trajectories received by the behavior data reception module 114 into a plurality of sub-trajectories. In the example of FIG. 4, sub-trajectories 402 are shown. In the illustrated example, the sub-trajectories 402 each have a length of ω. As such, the sub-trajectory generation module 116 generates modified behavior data.

Referring back to FIG. 3, at step 304, the diffusion model training module 118 trains a diffusion model, based on the modified behavior data generated by the sub-trajectory generation module 116, to receive Gaussian noise of length ω and output a predicted behavior trajectory having length ω, thereby generating a trained diffusion model. FIG. 4 illustrates a trained diffusion model 404.

Referring back to FIG. 3, at step 306, the neural network training module 120 trains a neural network, based on the behavior data received by the behavior data reception module 114, to receive a state and an action as inputs and output a predicted reward, thereby generating a trained neural network. FIG. 4 illustrates a trained neural network 406 as a reward predictor. As shown in FIG. 4, the neural network 406 receives an input state sₜ and an input action aₜ and outputs a predicted reward rₜ.

Referring back to FIG. 3, at step 308, the guided diffusion module 122 uses a guided diffusion process on the trained diffusion model to generate a plurality of target sub-trajectories of length ω. In particular, the guided diffusion module 122 may use a guidance function including a positive term based on a gradient of the target policy and a negative term based on a gradient of the behavior policy. FIG. 4 illustrates a policy guidance function 408 that includes a positive term ∇_{τ}, log π(aₜ|sₜ) and a negative term ∇_{τ} log β(aₜ|s_{y}).

Referring back to FIG. 3, at step 310, the trajectory concatenation module 124 concatenates the target sub-trajectories generated by the guided diffusion module 122 to generate target trajectories of length T based on the target policy. This is illustrated in FIG. 4 by the target trajectories 410.

Referring back to FIG. 3, at step 312, the trajectory evaluation module 126 evaluates the target trajectories output by the trajectory concatenation module 124 using the neural network trained by the neural network training module 120. In particular, the trajectory evaluation module 126 determines a predicted reward for each such trajectory. This is illustrated in FIG. 4 with the off-policy evaluation function 412 of

$$J ( π ) = {𝔼}_{{p}_{π}^{ω} [ {\sum }_{t} {γ}^{t} \hat{r} ( {s}_{t} , {a}_{t} ) ]} .$$

In some examples, the computing device 100 may control a robot based on the target policy associated with the target trajectories if the predicted reward output by the trajectory evaluation module 126 is above a predetermined threshold.

It should now be understood that embodiments described herein are directed to diffusion off-policy evaluation. By training a diffusion policy on sub-trajectories with a truncated horizon and condition on the last state of the previously-sampled sub-trajectory, the fidelity of trajectory generation on long-horizon tasks is significantly improved. Furthermore, incorporating a guidance function utilizing a negative score function of the behavior policy, the guided generation is mitigated from collapsing to trajectories with largest behavior likelihood, thereby improving out-of-data generalization. Accordingly, the embodiments disclosed herein provide for improved off-policy evaluation of robot trajectories.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving behavior data comprising a plurality of robot trajectories associated with a behavior policy, each of the robot trajectories having a first length;
dividing each of the robot trajectories into a plurality of sub-trajectories, each having a second length smaller than the first length, to generate modified behavior data;
training a diffusion model, based on the modified behavior data, to receive Gaussian noise having the second length as input, and output a predicted behavior trajectory having the second length, thereby generating a trained diffusion model;
training a neural network, based on the behavior data, to receive a state and an action as inputs and output a predicted reward, thereby generating a trained neural network;
using a guided diffusion process on the trained diffusion model to generate a plurality of target sub-trajectories, having the second length, based on a target policy;
concatenating the target sub-trajectories to generate a target trajectory having the first length; and
evaluating the target trajectory using the trained neural network.

2. The method of claim 1, further comprising evaluating the target trajectory by determining a reward associated with the target trajectory.

3. The method of claim 2, further comprising determining the reward associated with the target trajectory by determining rewards associated with state-action pairs of the target trajectory and determining an average of the rewards.

4. The method of claim 3, further comprising determining the reward associated with the target trajectory by using a discount factor to determine a weighted average of the rewards.

5. The method of claim 1, wherein a guidance function associated with the guided diffusion process is based on a gradient of the target policy and a gradient of the behavior policy.

6. The method of claim 5, wherein the guidance function associated with the guided diffusion process includes a positive term based on the gradient of the target policy.

7. The method of claim 5, wherein the guidance function associated with the guided diffusion process includes a negative guidance term based on the gradient of the behavior policy.

8. The method of claim 1, wherein the training of the diffusion model is conditioned on a previous state of a previously generated sub-trajectory.

9. The method of claim 2, further comprising controlling a robot based on the target policy if the reward associated with the target policy is above a predetermined threshold.

10. A computing device comprising one or more processors configured to:
receive behavior data comprising a plurality of robot trajectories associated with a behavior policy, each of the robot trajectories having a first length;
divide each of the robot trajectories into a plurality of sub-trajectories, each having a second length smaller than the first length, to generate modified behavior data;
train a diffusion model, based on the modified behavior data, to receive Gaussian noise having the second length as input, and output a predicted behavior trajectory having the second length, thereby generating a trained diffusion model;
train a neural network, based on the behavior data, to receive a state and an action as inputs and output a predicted reward, thereby generating a trained neural network;
use a guided diffusion process on the trained diffusion model to generate a plurality of target sub-trajectories, having the second length, based on a target policy;
concatenate the target sub-trajectories to generate a target trajectory having the first length; and
evaluate the target trajectory using the trained neural network.

11. The computing device of claim 10, wherein the one or more processors are further configured to evaluating the target trajectory by determining a reward associated with the target trajectory.

12. The computing device of claim 11, wherein the one or more processors are further configured to determine the reward associated with the target trajectory by determining rewards associated with state-action pairs of the target trajectory and determining an average of the rewards.

13. The computing device of claim 12, wherein the one or more processors are further configured to determine the reward associated with the target trajectory by using a discount factor to determine a weighted average of the rewards.

14. The computing device of claim 10, wherein a guidance function associated with the guided diffusion process is based on a gradient of the target policy and a gradient of the behavior policy.

15. The computing device of claim 14, wherein the guidance function associated with the guided diffusion process includes a positive term based on the gradient of the target policy.

16. The computing device of claim 14, wherein the guidance function associated with the guided diffusion process includes a negative guidance term based on the gradient of the behavior policy.

17. The computing device of claim 10, wherein the training of the diffusion model is conditioned on a previous state of a previously generated sub-trajectory.

18. The computing device of claim 11, wherein the one or more processors are further configured to control a robot based on the target policy if the reward associated with the target policy is above a predetermined threshold.

19. A non-transitory computer readable storage medium storing a program that when executed by one or more processors, causes the one or more processors to:
receive behavior data comprising a plurality of robot trajectories associated with a behavior policy, each of the robot trajectories having a first length;
divide each of the robot trajectories into a plurality of sub-trajectories, each having a second length smaller than the first length, to generate modified behavior data;
train a diffusion model, based on the modified behavior data, to receive Gaussian noise having the second length as input, and output a predicted behavior trajectory having the second length, thereby generating a trained diffusion model;
train a neural network, based on the behavior data, to receive a state and an action as inputs and output a predicted reward, thereby generating a trained neural network;
use a guided diffusion process on the trained diffusion model to generate a plurality of target sub-trajectories, having the second length, based on a target policy;
concatenate the target sub-trajectories to generate a target trajectory having the first length; and
evaluate the target trajectory using the trained neural network.

20. The non-transitory computer readable storage medium claim 19, wherein a guidance function associated with the guided diffusion process is based on a gradient of the target policy and a gradient of the behavior policy.
